(19) United States
(12) Patent Application Publication
(10) Pub. No.: US 2004/0188343 A1
(43) Pub. Date: Sep. 30, 2004

(54) Filter for electrically-driven pumps for motor vehicle windscreen washer systems

(76) Inventors: Mercedes Pujol Artigas, Barcelona (ES); Miguel Mota Lopez, Rubi (ES)

Correspondence Address: SUGHRUE MION, PLLC, 2100 PENNSYLVANIA AVENUE, N.W., SUITE 800, WASHINGTON, DC, 20037, US

(21) Appl. No.: 10/482,806

(22) PCT Filed: May 27, 2002
(86) PCT No.: PCT/ES02/00249

(30) Foreign Application Priority Data
Jul. 3, 2001 (ES) P 0101541

(51) Int. Cl. B01D 29/07; B01D 35/16

(52) U.S. Cl. 210/338; 210/436; 210/437; 210/497.1

(57) ABSTRACT

The invention relates to a filter (1) comprising a body (2) and a tubular filtering mesh (3) which are connected to one another.Said body (2) consists of a first cylindrical portion (4) which is axially connected to a second cylindrical portion (5). An opening (8) passes through both portions (4 and 5) in an axial manner and forms an inlet (9) in the first portion (4) and a base (10) in the second portion (5). The second portion (5) is provided with two identical suction openings (12) which are disposed diagonally in relation to one another. The tubular filtering mesh (3), which is provided with an internal diameter that coincides with that of the axial opening (8), is disposed coaxially in the second portion (5). One end of said mesh is encased in the first portion (4) while the other end is encased in the base (10) of the second portion (5).

### TECHNICAL SECTOR OF THE INVENTION

The object of the invention is a filter for electric pumps of motor vehicle windscreen washer systems.

### BACKGROUND TO THE INVENTION

It is well known that motor vehicle window washer systems essentially comprise a cleaning liquid deposit arranged, for example, in the motor compartment, a cleaning liquid suction-impelling electric pump, the cleaning liquid deposit being coupled, and some conduits for connecting the output of the electric pump with the jets which squirt the cleaning liquid onto the windscreen, rear window, etc. It is common practice for the electric pump to have a suction tubular extension, which vertically goes through one wall of the cleaning liquid deposit and is arranged within the latter.

The coupling of the electric pump to the deposit is done by securing means, which are coupled to an orifice in the deposit wall and which go through the suction tubular projection of the electric pump by means of tightening; in addition, to avoid the intake of solid bodies in suspension in the cleaning liquid cavity there is a filtering element of the liquid sucked in by the electric pump. In general, the assembly formed by said securing means and filtering element is designated as the filter.

As an example of an embodiment of filter for electric pumps for windscreen washers it is worth mentioning the one described in the publication of EP 0 792 780 of the same applicant, in which its constituent elements, that is, its securing means and a filtering element, are formed by a single body. Generally speaking, the main drawbacks of the disclosed embodiments of filters is that they have a high production cost and/or that of requiring, at the manufacturing place, several workings on the electric pump during the priming of the windscreen washer system.

### EXPLANATION OF THE INVENTION

With the aim of providing a solution to the previously described problems which known embodiments of filters for electric pumps of windscreen washer systems present, a filter with a new structure and functionality is herein disclosed.

The filter for electric pumps in window washer systems for motor vehicles object of the invention, comprises a body in which a first essentially cylindrical portion can be distinguished, which connects co-axially with a second portion that is also essentially cylindrical and smaller in diameter.

The filter is characterised in that said first and second portions are pierced co-axially by an orifice of a continuous section, which forms a mouth in the first portion and a bottom in the second portion, the second portion having two suction vents which are identical and diametrically arranged to one another and an interior and co-axial filtering tubular mesh, the interior diameter of the filtering mesh coinciding with the diameter of the orifice that axially goes through both first and second portions.

According to another feature of the filter of the invention, the suction vents extend between the first portion and the bottom of the second portion.

Another feature of the invention is that one end of the filtering mesh is included in the first portion, whereas the other end is included in the bottom of the second portion.

Another feature of the invention consists of the fact that the connection between the first and second portions forms a truncated-cone shaped portion.

According to another feature of the invention, the outer edge of the mouth of the first portion is provided with a chamfering.

It is also characteristic of the filter of the invention that the first portion is provided with a cantilevered outer annular perimeter portion.

### BRIEF DESCRIPTION OF THE DRAWINGS

In the attached drawings a form of embodiment of the filter for electric pumps of motor vehicle windscreen washer systems object of the invention is illustrated by way of non-limiting example. In said drawings:

FIG. 1 is a side view of the filter according to the invention:

FIG. 2 is the view corresponding to section II-II of FIG. 1; and

FIG. 3 is the view corresponding to section III-III of FIG. 1.

### DETAILED DESCRIPTION OF THE DRAWINGS

The filter 1 for electric pumps of motor vehicle windscreen washer systems, which is represented as an embodiment example, comprises a single-piece member 2 and a filtering tubular mesh 3, which can be mutually coupled.

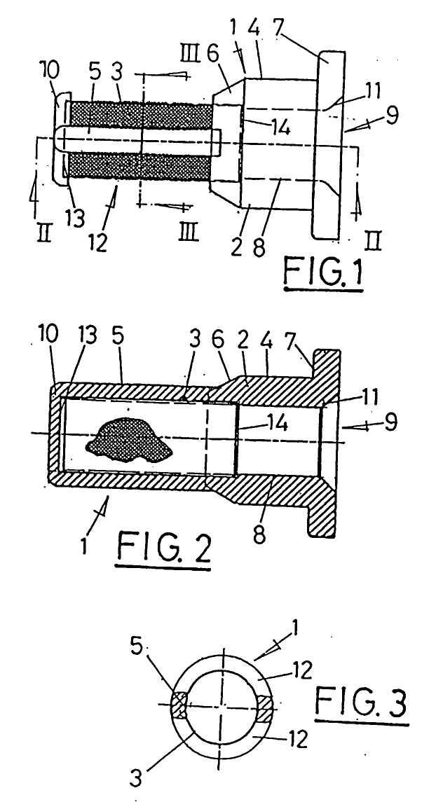

In FIGS. 1 and 2 it can be appreciated that the single-piece member 2 comprises an essentially cylindrical first portion 4, which connects co-axially with a second portion 5, which is also essentially cylindrical and smaller in diameter than the first portion 4, said connection forming a truncated-cone shaped portion 6. The outer end of the first portion 4 is provided with a cantilevered annular perimeter portion 7. The first cylindrical portion 4 and the perimeter portion 7 determine the securing means of the filter 1 to an orifice made to that end in a cleaning liquid deposit for windscreen washer systems which, for the purposes of simplification, have not been represented.

In FIG. 2 it can be appreciated that the first portion 4 and the second portion 5 axially go through a circular orifice 8, which in the first cylindrical portion 4, forms an input mouth 9, and in the second cylindrical portion 5, a bottom 10. The mouth 9 has a chamfering 11 and the axial orifice 8 is dimensioned for receiving by tightening the tubular suction extension of an electric pump which, for the previously indicated reasons, have not been represented, the mouth 9 being intended for easing the entry into the axial orifice 8 of said tubular suction extension during the coupling of the electric pump to the filter 1.

The second cylindrical portion 5 is provided with two suction apertures 12, equal to one another and diametrically arranged with respect to each other as can be appreciated in FIGS. 1 and 3. Both suction apertures 12 extend between the inner end of the first cylindrical portion 4 and the bottom 10 of the second cylindrical portion 5.

In FIGS. 1 and 2 it can be appreciated that the filtering tubular mesh 3 is arranged in the inside of the second cylindrical portion 5 and co-axially with respect to the same and as a consequence also co-axially arranged with respect to the first cylindrical portion 4, the inner diameter of the filtering tubular mesh 3 being coincident with the diameter of the orifice 8 that goes through both portions 4 and 5. One end 13 of the filtering tubular mesh 3 is fitted into the bottom 10 of the second cylindrical portion 5 and the other end 14 is fitted into the first cylindrical portion 4. With this arrangement, the coupling of said electric pump to the filter 1 is done in such a way that its suction tubular extension is situated with its suction end arranged next to the bottom 10 and facing the suction apertures 12, with the interposition of the filtering tubular mesh 3.

Preferentially, the filtering tubular mesh is obtained from poly-propylene with a thread of thickness of 165 μm and a span of 210 μm.

From the tests carried out by the inventor, the arrangement of the filter for electric pumps of motor vehicle windscreen washer systems object of the invention and which has been described as an embodiment example, makes the priming of the windscreen washer system easy, without the need to repeatedly operate on the electric pump. In addition, the structure of the filter described enables it to be produced at a lower cost than known filter embodiments.

1. (Original) Filter for electric pumps of motor vehicle windscreen washer systems, which comprises a body (2) in which a first essentially cylindrical portion (4) can be distinguished, which connects co-axially with a second portion (5) that is also essentially cylindrical and smaller in diameter, which is characterised in that said first (4) and second (5) portions are pierced co-axially by an orifice (8) of a constant section, which forms a mouth (9) in the first portion (4) and a bottom (10) in the second portion (5), the second portion (5) having two suction vents (12) which are identical and diametrically arranged to one another, and an interior and co-axial filtering tubular mesh (3), the interior diameter of the filtering mesh (3) coinciding with the diameter of the orifice (8) that axially goes through both first (4) and second (5) portions.

2. (Original) Filter for electric pumps according to claim 1, which is characterised in that the suction vents (12) extend between the first portion (4) and the bottom (10) of the second portion (5).

3. (Original) Filter for electric pumps according to claim 1, which is characterised in that one end (14) of the tubular filtering mesh (3) is fitted into the first portion (4), whereas the other end (13) is fitted into the bottom (10) of the second portion (5).

4. (Original) Filter for electric pumps according to claim 1, which is characterised in that the connection between the first (4) and second (5) portions forms a truncated-cone shaped portion (6).

5. (Cancelled).

6. (Original) Filter for electric pumps according to claim 1, which is characterised in that the first portion (4) is provided with a cantilevered outer annular perimeter portion (7).
